(19) United States
(12) Patent Application Publication
(10) Pub. No.: US 2016/0168287 A1
(43) Pub. Date: Jun. 16, 2016

(54) PROCESS FOR THE PREPARATION OF PROPYLENE COPOLYMER CONTAINING HIGHER ALPHA-OLEFINS

(71) Applicant: BOREALIS AG, Vienna (AT)

(72) Inventors: Kristin Reichelt, Neuhofen/Krems (AT); Luigi Resconi, Ferrara (IT); Robert Pellecchia, Linz (AT)

(21) Appl. No.: 14/905,612

(22) PCT Filed: Jul. 17, 2014
(86) PCT No.: PCT/EP2014/065398

§ 371 Date: Jan. 15, 2016

(30) Foreign Application Priority Data
Aug. 2, 2013 (EP) 13179112.1

(51) Int. Cl. C08F 210/06

(52) U.S. Cl. CPC C08F 210/06

(57) ABSTRACT

Process for the preparation of a copolymer of propylene and a C₄₋₁₂ a-olefin (PPC) having a melt flow rate MFR₂ (230° C.) of below 3.0 g/10 mm, wherein the polymerization takes in the presence of a metallocene catalyst.

The present invention is directed to a new way of preparation of a copolymer of propylene and a C₄₋₁₂ α-olefin.

Copolymers of propylene and a C₄₋₁₂ α-olefin are widely used, like in the film processing. Such type of polymers is quite often used because of their good optical properties and their good sealing performance. Such copolymers are preferably produced with a metallocene catalyst. However it is quite difficult to produce copolymers of propylene and a C₄₋₁₂ α-olefin with rather low melt flow rate in an economic way, i.e. with high productivity.

In EP 2 540 497, EP 2 540 499 and EP 2 540 496 the manufacture of articles based on propylene-1-hexene copolymers is described. In all three applications the copolymers are produced in the presence of rac-cyclohexyl(methyl)silanediylbis[2-methyl-4-(4′-tert-butylphenyl)indenyl]zirconium dichloride. The molecular weight capability of this catalyst is however not satisfying. This means that incorporation of higher alpha-olefin comonomers leads to lower molecular weights.

WO 2013/007650 A1 defines assymetric catalyst suitable for the preparation of propylene copolymers. However the problem of molecular weight capability in the manufacture of propylene copolymers with comonomers of higher α-olefins has not been addressed.

Thus the object of the present invention is to provide a process in which copolymers of propylene and a C₄₋₁₂ α-olefin having high molecular weight can be produced with reasonable productivity.

The finding of the present invention is that copolymers of propylene and a C₄₋₁₂ α-olefin with rather high molecular weight can be produced in the presence of an asymmetric single site metallocene complex.

Accordingly, the present invention is directed to a process for the preparation of a copolymer of propylene and a C₄₋₁₂ α-olefin (PPC), said copolymer (PPC) has a melt flow rate MFR₂ (230° C.) measured according to ISO 1133 of below 3.0 g/10 min,

wherein propylene and C₄₋₁₂ α-olefin are polymerized in the presence of a catalyst, said catalyst comprises an asymmetrical complex of formula (I)

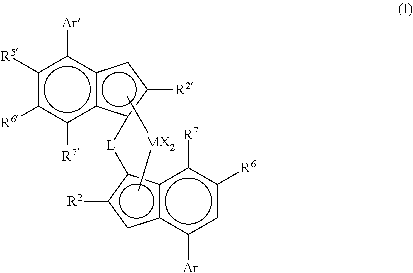

wherein

M is zirconium or hafnium;

each X is a sigma ligand;

L is a divalent bridge selected from —R′₂C—, —R′₂C—CR′₂—, —R′₂Si—, —R′₂Si—SiR′₂—, —R′₂Ge—, wherein each R′ is independently a hydrogen atom, C₁₋₂₀-hydrocarbyl, tri(C₁₋₂₀-alkyl)silyl, C₆₋₂₀-aryl, C₇₋₂₀-arylalkyl or C₇₋₂₀-alkylaryl;

R² and R²′ are each independently a C₁₋₂₀ hydrocarbyl radical optionally containing one or more heteroatoms from groups 14-16;

R⁵ is a C₁₋₂₀ hydrocarbyl group optionally containing one or more heteroatoms from groups 14-16 and optionally substituted by one or more halo atoms;

R⁶ and R^{6′} are each independently hydrogen or a C₁₋₂₀ hydrocarbyl group optionally containing one or more heteroatoms from groups 14-16;

R⁷ and R^{7′} are each independently hydrogen or C₁₋₂₀ hydrocarbyl group optionally containing one or more heteroatoms from groups 14-16;

Ar is an aryl or heteroaryl group having up to 20 carbon atoms optionally substituted by one or more groups R¹;

Ar′ is an aryl or heteroaryl group having up to 20 carbon atoms optionally substituted by one or more groups R¹;

each R¹ is a C₁₋₂₀ hydrocarbyl group or two R¹ groups on adjacent carbon atoms taken together can form a fused 5 or 6 membered non aromatic ring with the Ar group, said ring being itself optionally substituted with one or more groups R⁴; and

each R⁴ is a C₁₋₂₀ hydrocarbyl group.

Preferred embodiments of the present invention are especially discussed in the dependent claim.

In the following the invention will be defined in more detail. First the used catalyst is defined, subsequently the polymerization process in which said catalyst is employed as well as the copolymer (PPC) obtained.

The Catalyst

As mentioned above the catalyst must comprise an asymmetrical complex. Additionally the catalyst may comprise a cocatalyst.

Preferably the molar-ratio of cocatalyst (Co) to the metal (M) of the complex, like Zr, [Co/M] is below 500, more preferably in the range of more than 100 to below 500, still more preferably in the range of 150 to 450, yet more preferably in the range of 200 to 450.

In one embodiment the catalyst is used in the form of a catalyst composition, said composition comprises a polymer matrix in which the catalyst is distributed. The term “distributed” in this regard shall preferably indicate that the catalyst system is not concentrated at one place within the polymer matrix but (evenly) dispersed within the polymer matrix. This has the advantage that—contrary to commercially available supported catalyst systems—an overheating at the beginning of the polymerization process due to “hot spots” areas caused by concentration of catalytic species at one place is diminished which in turn supports a start of the polymerization in a controlled way under mild conditions. The even distribution of catalyst in polymer matrix is mainly achieved due to the manufacture of the catalyst composition as described in WO 2010/052260.

A further characteristic of the catalyst composition according to the present invention is that the catalyst within the catalyst composition is protected against dissolution phenomena in a slurry reactor, i.e. in low molar mass hydrocarbons, like propane, iso-butane, pentane, hexane or propylene. On the other hand the protection of the catalyst should be not too massive otherwise the catalytic activity of the active species might be deteriorated. In the present invention the conflicting interests on the one hand of high catalytic activity of the catalyst and on the other hand of the solid stability of the catalyst in the polymerization medium of the slurry reactor is achieved by protecting the catalyst by a polymer matrix wherein the polymer matrix is present in rather low amounts within the catalyst composition. Rather low weight ratio of polymer matrix to catalyst [weight polymer matrix/weight catalyst], also named polymerization degree, leads to a satisfactory protection against dissolution by keeping the catalyst on high levels. Accordingly it is appreciated that the polymerization degree [weight polymer matrix/weight catalyst] is below 25.0, more preferably below 15.0, yet more preferably below 10.0, still yet more preferably below 5.0. On the other hand to achieve a reasonable protection against dissolution the polymerization degree [weight polymer matrix/weight catalyst] shall preferably exceed a value of 0.5, more preferably of 0.7, yet more preferably of 1.0. Preferred ranges of the polymerization degree [weight polymer matrix/weight catalyst] shall be 0.7 to 10.0, more preferably 1.0 to 8.0, yet more preferably 1.0 to 6.0, still more preferably 1.0 to 5.0, still yet more preferably of 2.0 to 5.0.

The polymer matrix can be any type of polymer as long as it prevents the dissolution of the catalyst in the polymerization medium of a slurry reactor, i.e. low molar mass hydrocarbons, like propane, iso-butane, pentane, hexane or propylene, and is catalytically inert. Accordingly the polymer matrix is preferably based on olefin monomers, like α-olefin monomers, each having 2 to 20 carbon atoms. The olefin, like α-olefin, can be linear or branched, cyclic or acyclic, aromatic or aliphatic. Preferred examples are ethylene, propylene, 1-butene, 3-methyl-1-butene, 3-methyl-1-pentene, 4-methyl-1-pentene, styrene, and vinylcyclohexane.

It is in particular preferred that the polymer matrix corresponds to the polymer which shall be produced with the inventive solid catalyst composition. Accordingly it is preferred that the polymer matrix is preferably a polymer selected from the group consisting of ethylene homopolymer, ethylene copolymer, propylene homopolymer and propylene copolymer. In one embodiment the polymer matrix is a propylene homopolymer.

Concerning the preparation of the catalyst composition as defined above reference is made to WO 2010/052260.

The Complex of the Catalyst

The single site metallocene complex, especially the complexes defined by the formulas specified in the present invention, used for manufacture of the copolymer (PPC) are asymmetrical. That means that the two indenyl ligands forming the metallocene complex are different, that is, each indenyl ligand bears a set of substituents that are either chemically different, or located in different positions with respect to the other indenyl ligand. More precisely, they are chiral, racemic bridged bisindenyl metallocene complexes. Whilst the complexes of the invention may be in their syn configuration, ideally they are in their anti configuration. For the purpose of this invention, racemic-anti means that the two indenyl ligands are oriented in opposite directions with respect to the cyclopentadienyl-metal-cyclopentadienyl plane, while racemic-syn means that the two indenyl ligands are oriented in the same direction with respect to the cyclopentadienyl-metal-cyclopentadienyl plane, as shown in the Figure below.

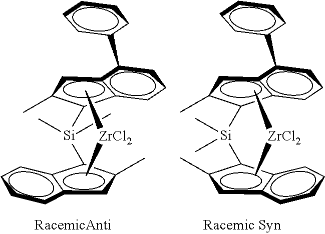

Formula (I) is intended to cover both syn and anti configurations, preferably anti. It is required in addition, that the group R⁵ is not hydrogen where the 5-position in the other ligand carries a hydrogen.

In fact, the metallocene complexes of use in the invention are C₁-symmetric but they maintain a pseudo-C₂-symmetry since they maintain C₂-symmetry in close proximity of the metal center, although not at the ligand periphery. The use of two different indenyl ligands as described in this invention allows for a much finer structural variation, hence a more precise tuning of the catalyst performance, compared to the typical C₂-symmetric catalysts. By nature of their chemistry, both anti and syn enantiomer pairs are formed during the synthesis of the complexes. However, by using the ligands of this invention, separation of the preferred anti isomers from the syn isomers is straightforward.

It is preferred if the metallocene complexes of the invention are employed as the rac anti isomer. Ideally therefore at least 95% mol, such as at least 98% mol, especially at least 99% mol of the metallocene catalyst is in the racemic anti isomeric form.

In the complex of use in the invention:

M is preferably Zr.

Each X, which may be the same or different, is preferably a hydrogen atom, a halogen atom, a R, OR, OSO₂CF₃, OCOR, SR, NR₂ or PR₂ group wherein R is a linear or branched, cyclic or acyclic, C₁₋₂₀ alkyl, C₂₋₂₀ alkenyl, C₂₋₂₀ alkynyl, C₆₋₂₀ aryl, C₇₋₂₀ alkylaryl or C₇₋₂₀ arylalkyl radical; optionally containing heteroatoms belonging to groups 14-16. R is preferably a C₁₋₆ alkyl, phenyl or benzyl group.

Most preferably each X is independently a hydrogen atom, a halogen atom, C₁₋₆ alkoxy group or an R group, e.g. preferably a C₁₋₆ alkyl, phenyl or benzyl group. Most preferably X is chlorine or a methyl radical. Preferably both X groups are the same.

L is preferably an alkylene linker or a bridge comprising a heteroatom, such as silicon or germanium, e.g. —SiR⁸₂—, wherein each R⁸ is independently C₁₋₂₀ alkyl, C₃₋₁₀ cycloakyl, C₆₋₂₀ aryl or tri(C₁₋₂₀ alkyl)silyl, such as trimethylsilyl. More preferably R⁸ is C₁₋₆ alkyl, especially methyl or C₃₋₇ cycloalkyl, such as cyclohexyl. Most preferably, L is a dimethylsilyl or a methylcyclohexylsilyl bridge (i.e. Me-Si-cyclohexyl). It may also be an ethylene bridge.

R² and R^{2′} can be different but they are preferably the same. R² and R^{2′} are preferably a C₁₋₁₀ hydrocarbyl group such as C₁₋₆ hydrocarbyl group. More preferably it is a linear or branched C₁₋₁₀ alkyl group. More preferably it is a linear or branched C₁₋₆ alkyl group, especially linear C₁₋₆ alkyl group such as methyl or ethyl.

The R² and R^{2′} groups can be interrupted by one or more heteroatoms, such as 1 or 2 heteroatoms, e.g. one heteroatom, selected from groups 14 to 16 of the periodic table. Such a heteroatom is preferably O, N or S, especially O. More preferably however the R² and R^{2′} groups are free from heteroatoms. Most especially R² and R^{2′} are methyl, especially both methyl.

The two Ar groups Ar and Ar′ can be the same or different. The Ar′ group may be unsubstituted. The Ar′ is preferably a phenyl based group optionally substituted by groups R¹, especially an unsubstituted phenyl group.

The Ar group is preferably a C₆₋₂₀ aryl group such as a phenyl group or naphthyl group. Whilst the Ar group can be a heteroaryl group, such as carbazolyl, it is preferable that Ar is not a heteroaryl group. The Ar group can be unsubstituted or substituted by one or more groups R¹, more preferably by one or two R¹ groups, especially in position 4 of the aryl ring bound to the indenyl ligand or in the 3, 5-positions.

In one embodiment both Ar and Ar′ are unsubstituted. In another embodiment Ar′ is unsubstituted and Ar is substituted by one or two groups R¹.

R¹ is preferably a C₁₋₂₀ hydrocarbyl group, such as a C₁₋₂₀ alkyl group. R¹ groups can be the same or different, preferably the same. More preferably, R¹ is a C₂₋₁₀ alkyl group such as C₃₋₈ alkyl group. Highly preferred groups are tert butyl or isopropyl groups. It is preferred if the group R¹ is bulky, i.e. is branched. Branching might be alpha or beta to the ring. Branched C₃₋₈ alkyl groups are also favoured therefore.

In a further embodiment, two R¹ groups on adjacent carbon atoms taken together can form a fused 5 or 6 membered non aromatic ring with the Ar group, said ring being itself optionally substituted with one or more groups R⁴. Such a ring might form a tetrahydroindenyl group with the Ar ring or a tetrahydronaphthyl group.

If an R⁴ group is present, there is preferably only 1 such group. It is preferably a C₁₋₁₀ alkyl group.

It is preferred if there is one or two R¹ groups present on the Ar group. Where there is one R¹ group present, the group is preferably para to the indenyl ring (4-position). Where two R¹ groups are present these are preferably at the 3 and 5 positions.

R⁵ is preferably a C₁₋₂₀ hydrocarbyl group containing one or more heteroatoms from groups 14-16 and optionally substituted by one or more halo atoms or R⁵ is a C₁₋₁₀ alkyl group, such as methyl but most preferably it is a group Z′R^{3′}.

R⁶ and R^{6′} may be the same or different. In one preferred embodiment one of R⁶ and R^{6′} is hydrogen, especially R⁶. It is preferred if R⁶ and R^{6′} are not both hydrogen. If not hydrogen, it is preferred if each R⁶ and R^{6′} is preferably a C₁₋₂₀ hydrocarbyl group, such as a C₁₋₂₀ alkyl group or C₆₋₁₀ aryl group. More preferably, R⁶ and R^{6′} are a C₂₋₁₀ alkyl group such as C₃₋₈ alkyl group. Highly preferred groups are tert-butyl groups. It is preferred if R⁶ and R^{6′} are bulky, i.e. are branched. Branching might be alpha or beta to the ring. Branched C₃₋₈ alkyl groups are also favoured therefore.

The R⁷ and R^{7′} groups can be the same or different. Each R⁷ and R^{7′} group is preferably hydrogen, a C₁₋₆ alkyl group or is a group ZR³. It is preferred if R^{7′} is hydrogen. It is preferred if R⁷ is hydrogen, C₁₋₆ alkyl or ZR³. The combination of both R⁷ and R^{7′} being hydrogen is most preferred. It is also preferred if ZR³ represents OC₁₋₆ alkyl, such as methoxy. It is also preferred is R⁷ represents C₁₋₆ alkyl such as methyl.

Z and Z′ are O or S, preferably O.

R³ is preferably a C₁₋₁₀ hydrocarbyl group, especially a C₁₋₁₀ alkyl group, or aryl group optionally substituted by one or more halo groups. Most especially R³ is a C₁₋₆ alkyl group, such as a linear C₁₋₆ alkyl group, e.g. methyl or ethyl.

R^{3′} is preferably a C₁₋₁₀ hydrocarbyl group, especially a C₁₋₁₀ alkyl group, or aryl group optionally substituted by one or more halo groups. Most especially R^{3′} is a C₁₋₆ alkyl group, such as a linear C₁₋₆ alkyl group, e.g. methyl or ethyl or it is a phenyl based radical optionally substituted with one or more halo groups such as Ph or C₆F₅.

Thus, preferred complexes of the invention are of formula (II) or (II′)

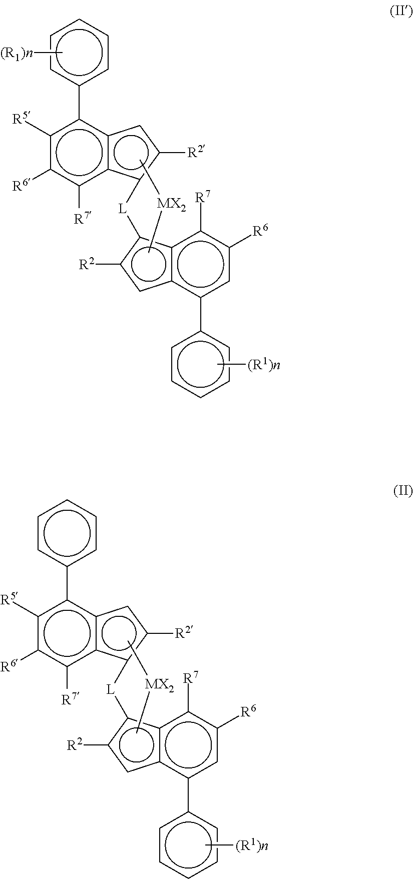

wherein

M is zirconium or hafnium;

each X is a sigma ligand, preferably each X is independently a hydrogen atom, a halogen atom, C₁₋₆ alkoxy group, C₁₋₆ alkyl, phenyl or benzyl group;

L is a divalent bridge selected from —R′₂C—, —R′₂C—CR′₂—, —R′₂Si—, —R′₂Si—SiR′₂—, —R′₂Ge—, wherein each R′ is independently a hydrogen atom, C₁₋₂₀ alkyl, C₃₋₁₀ cycloalkyl, tri(C₁₋₂₀-alkyl)silyl, C₆₋₂₀-aryl, C₇₋₂₀ arylalkyl or C₇₋₂₀ alkylaryl;

each R² or R^{2′} is a C₁₋₁₀ alkyl group;

R⁵ is a C₁₋₁₀ alkyl group or Z′R^{3′} group;

R⁶ is hydrogen or a C₁₋₁₀ alkyl group;

R⁶ is a C₁₋₁₀ alkyl group or C₆₋₁₀ aryl group;

R⁷ is hydrogen, a C₁₋₆ alkyl group or ZR³ group;

R⁷ is hydrogen or a C₁₋₁₀ alkyl group;

Z and Z′ are independently O or S;

R^{3′} is a C₁₋₁₀ alkyl group, or a C₆₋₁₀ aryl group optionally substituted by one or more halo groups;

R³ is a C₁₋₁₀-alkyl group;

Each n is independently 0 to 4, e.g. 0, 1 or 2;

and each R¹ is independently a C₁₋₂₀ hydrocarbyl group, e.g. C₁₋₁₀ alkyl group.

Further preferred complexes of the invention are those of formula (III) or (III′):

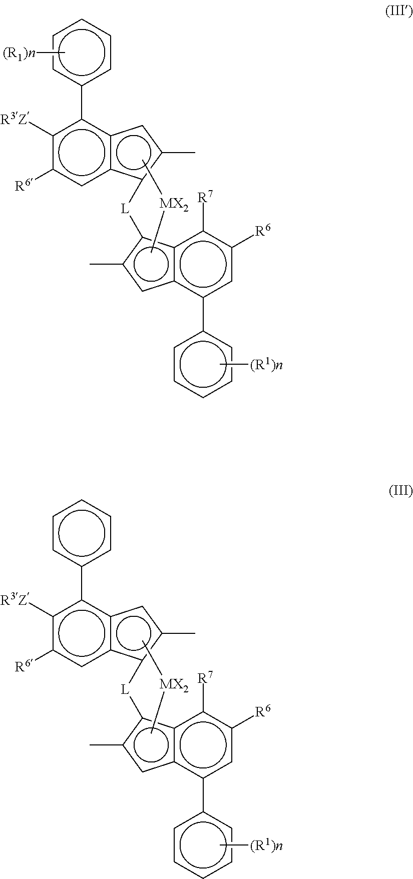

wherein

M is zirconium or hafnium;

each X is a sigma ligand, preferably each X is independently a hydrogen atom, a halogen atom, C₁₋₆ alkoxy group, C₁₋₆ alkyl, phenyl or benzyl group;

L is a divalent bridge selected from —R′₂C— or —R′₂Si— wherein each R′ is independently a hydrogen atom, C₁₋₂₀ alkyl or C₃₋₁₀ cycloalkyl;

R⁶ is hydrogen or a C₁₋₁₀ alkyl group;

R⁶ is a C₁₋₁₀ alkyl group or C₆₋₁₀ aryl group;

R⁷ is hydrogen, C₁₋₆ alkyl or OC₁₋₆ alkyl;

Z′ is O or S;

R^{3′} is a C₁₋₁₀ alkyl group, or C₆₋₁₀ aryl group optionally substituted by one or more halo groups;

n is independently 0 to 4, e.g. 0, 1 or 2; and

each R¹ is independently a C₁₋₁₀ alkyl group.

Further preferred complexes of use in the invention are those of formula (IV) or (IV′):

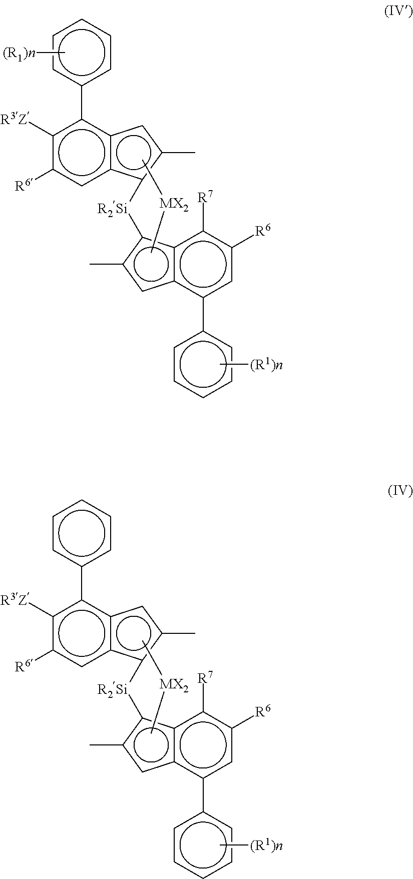

wherein

M is zirconium or hafnium;

each X is a sigma ligand, preferably each X is independently a hydrogen atom, a halogen atom, C₁₋₆-alkoxy group, C₁₋₆-alkyl, phenyl or benzyl group;

each R′ is independently a hydrogen atom, C₁₋₂₀ alkyl or C₃₋₇ cycloalkyl;

R⁶ is hydrogen or a C₁₋₁₀ alkyl group;

R⁶ is a C₁₋₁₀ alkyl group or C₆₋₁₀ aryl group;

R⁷ is hydrogen, C₁₋₆ alkyl or OC₁₋₆ alkyl;

Z′ is O or S;

R^{3′} is a C₁₋₁₀ alkyl group, or C₆₋₁₀ aryl group optionally substituted by one or more halo groups;

n is independently 0, 1 to 2; and

each R¹ is independently a C₃₋₈ alkyl group.

Most especially, the complex of use in the invention is of formula (V) or (V′):

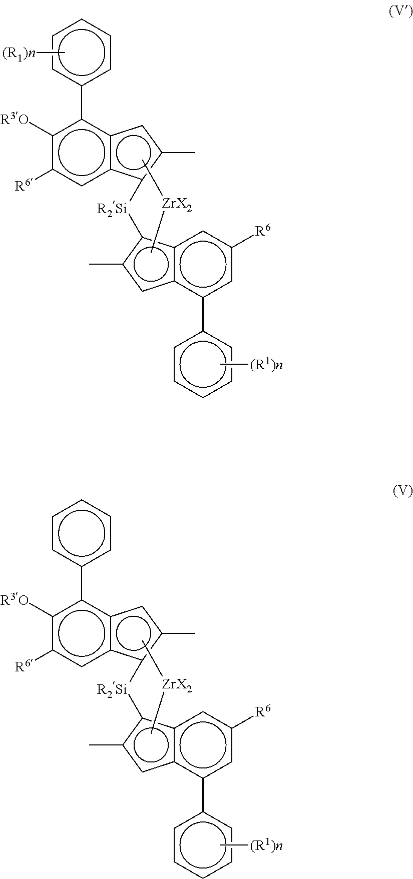

wherein

each X is a sigma ligand, preferably each X is independently a hydrogen atom, a halogen atom, C₁₋₆-alkoxy group, C₁₋₆-alkyl, phenyl or benzyl group;

R′ is independently a C₁₋₆ alkyl or C₃₋₁₀ cycloalkyl;

R¹ is independently C₃₋₈ alkyl;

R⁶ is hydrogen or a C₃₋₈ alkyl group;

R⁶ is a C₃₋₈ alkyl group or C₆₋₁₀ aryl group;

R^{3′} is a C₁₋₆ alkyl group, or C₆₋₁₀ aryl group optionally substituted by one or more halo groups; and

n is independently 0, 1 or 2.

Particular compounds of the invention include: rac-anti-Me₂Si(2-Me-4-Ph-6-tBu-Ind)(2-Me-4-Ph-5-OMe-6-tBu-Ind)ZrCl₂, rac-anti-Me₂Si(2-Me-4-(p-tBuPh)-Ind)(2-Me-4-Ph-5-OMe-6-tBu-Ind)ZrCl₂, rac-anti-Me₂Si(2-Me-4-(3,5-di-tBuPh)-6-tBu-Ind)(2-Me-4-Ph-5-OMe-6-tBu-Ind)ZrCl₂, rac-anti-Me₂Si(2-Me-4-Ph-6-tBu-Ind)(2-Me-4,6-di-Ph-5-OMe-Ind)ZrCl₂, rac-anti-Me₂Si(2-Me-4-(p-tBuPh)-Ind)(2-Me-4-Ph-5-OC₆F₅)-6-iPr-Ind)ZrCl₂, rac-anti-Me(CyHex)Si(2-Me-4-Ph-6-tBu-Ind)(2-Me-4-Ph-5-OMe-6-tBu-Ind)ZrCl₂, rac-anti-Me₂Si(2-Me-4-(3,5-di-tBuPh)-7-Me-Ind)(2-Me-4-Ph-5-OMe-6-tBu-Ind)ZrCl₂, rac-anti-Me₂Si(2-Me-4-(3,5-di-tBuPh)-7-OMe-Ind)(2-Me-4-Ph-5-OMe-6-tBu-Ind)ZrCl₂, rac-anti-Me₂Si(2-Me-4-(p-tBuPh)-6-tBu-Ind)(2-Me-4-Ph-5-OMe-6-tBu-Ind)ZrCl₂, rac-anti-Me₂Si(2-Me-4-(p-tBuPh)-Ind)(2-Me-4-(4-tBuPh)-5-OMe-6-tBu-Ind)ZrCl₂, rac-anti-Me₂Si(2-Me-4-(p-tBuPh)-Ind)(2-Me-4-(3,5-tBu2Ph)-5-OMe-6-tBu-Ind)ZrCl₂, and rac-anti-Me₂Si(2-Me-4-(p-tBuPh)-Ind)(2-Me-4-Ph-5-OiBu-6-tBu-Ind)ZrCl₂.

For the avoidance of doubt, any narrower definition of a substituent offered above can be combined with any other broad or narrowed definition of any other substituent.

Throughout the disclosure above, where a narrower definition of a substituent is presented, that narrower definition is deemed disclosed in conjunction with all broader and narrower definitions of other substituents in the application.

In one especially preferred embodiment the complex is rac-anti-Me₂Si(2-Me-4-(p-tBuPh)-Ind)(2-Me-4-Ph-5-OMe-6-tBu-Ind)ZrCl₂.

Concerning the synthesis of the complex according to this invention it is also referred to WO 2013/007650 A1.

The Cocatalyst of the Catalyst

To form an active catalytic species it is normally necessary to employ a cocatalyst as is well known in the art. Cocatalysts comprising one or more compounds of Group 13 metals, like organoaluminium compounds or borates used to activate metallocene catalysts are suitable for use in this invention.

Thus the catalyst according to this invention comprises (i) a complex as defined above and (ii) a cocatalyst, like an aluminium alkyl compound (or other appropriate cocatalyst), or the reaction product thereof. Thus the cocatalyst is preferably an alumoxane, like MAO or an alumoxane other than MAO.

Borate cocatalysts can also be employed. It will be appreciated by the skilled man that where boron based cocatalysts are employed, it is normal to preactivate the complex by reaction thereof with an aluminium alkyl compound, such as TIBA. This procedure is well known and any suitable aluminium alkyl, e.g. Al(C₁₋₆-alkyl)₃, can be used.

Boron based cocatalysts of interest include those of formula

BY₃

wherein Y is the same or different and is a hydrogen atom, an alkyl group of from 1 to about 20 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred examples for Y are trifluoromethyl, p-fluorophenyl, 3,5-difluorophenyl, pentafluorophenyl, 3,4,5-trifluorophenyl and 3,5-di(trifluoromethyl)phenyl. Preferred options are trifluoroborane, tris(4-fluorophenyl)borane, tris(3,5-difluorophenyl)borane, tris(4-fluoromethylphenyl)borane, tris(2,4,6-trifluorophenyl)borane, tris(penta-fluorophenyl)borane, tris(3,5-difluorophenyl)borane and/or tris (3,4,5-trifluorophenyl)borane.

Particular preference is given to tris(pentafluorophenyl)borane.

It is preferred however is borates are used, i.e. compounds of general formula [C]⁺[BX4]⁻. Such ionic cocatalysts contain a non-coordinating anion [BX4]⁻ such as tetrakis(pentafluorophenyl)borate. Suitable counterions [C]⁺ are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

Preferred ionic compounds which can be used according to the present invention include: tributylammoniumtetrakis(pentafluorophenyl)borate, tributylammoniumtetrakis(trifluoromethylphenyl)borate, tributylammoniumtetrakis(4-fluorophenyl)borate, N,N-dimethylcyclohexylammoniumtetrakis(pentafluorophenyl)borate, N,N-dimethylbenzylammoniumtetrakis(pentafluorophenyl)borate, N,N-dimethylaniliniumtetrakis(pentafluorophenyl)borate, N,N-di(propyl)ammoniumtetrakis(pentafluorophenyl)borate, di(cyclohexyl)ammoniumtetrakist(pentafluorophenyl)borate, triphenylcarbeniumtetrakis(pentafluorophenyl)borate, or ferroceniumtetrakis(pentafluorophenyl)borate. Preference is given to triphenylcarbeniumtetrakis(pentafluorophenyl) borate, N,N-dimethylcyclohexylammoniumtetrakis(pentafluorophenyl)borate or N,N-dimethylbenzylammoniumtetrakis(pentafluorophenyl)borate.

The use of B(C₆F₅)₃, C₆H₅N(CH₃)₂H:B(C₆F₅)₄, (C₆H₅)₃C:B(C₆F₅)₄ is especially preferred.

Catalyst Manufacture

The metallocene complex of the present invention can be used in combination with a suitable cocatalyst as a catalyst e.g. in a solvent such as toluene or an aliphatic hydrocarbon, (i.e. for polymerization in solution), as it is well known in the art. Preferably, polymerization takes place in the condensed phase or in gas phase.

The catalyst of the invention can be used in supported or unsupported form. The particulate support material used is preferably an organic or inorganic material, such as silica, alumina or zirconia or a mixed oxide such as silica-alumina, in particular silica, alumina or silica-alumina. The use of a silica support is preferred. The skilled man is aware of the procedures required to support a metallocene catalyst.

Especially preferably the support is a porous material so that the complex may be loaded into the pores of the support, e.g. using a process analogous to those described in WO94/14856 (Mobil), WO95/12622 (Borealis) and WO2006/097497. The particle size is not critical but is preferably in the range 5 to 200 μm, more preferably 20 to 80 μm. The use of these supports is routine in the art.

In preferred embodiment, no support is used at all. Such a catalyst can be prepared in solution, for example in an aromatic solvent like toluene, by contacting the metallocene (as a solid or as a solution) with the cocatalyst, for example methylaluminoxane or a borane or a borate salt, or can be prepared by sequentially adding the catalyst components to the polymerization medium. In a preferred embodiment, the metallocene (when X differs from alkyl or hydrogen) is prereacted with an aluminum alkyl, in a ratio metal/aluminum of from 1:1 up to 1:500, preferably from 1:1 up to 1:250, and then combined with the borane or borate cocatalyst, either in a separate vessel or directly into the polymerization reactor. Preferred metal/boron ratios are between 1:1 and 1:100, more preferably 1:1 to 1:10.

In one particularly preferred embodiment, no external carrier is used but the catalyst is still presented in solid particulate form. Thus no external support material such as inert organic or inorganic carrier, such as for example silica as described above is employed.

In order to provide the catalyst of the invention in solid form but without using an external carrier, it is preferred if a liquid/liquid emulsion system is used. The process involves forming dispersing catalyst components (i) and (ii), i.e. the complex and the cocatalyst, in a solvent, and solidifying said dispersed droplets to form solid particles.

Reference is made to WO2006/069733 describing principles of such a continuous or semicontinuous preparation methods of the solid catalyst types, prepared via emulsion/solidification method. For further details it is also referred to WO 2013/007650 A1.

The Polymerization

The copolymer of propylene and a C₄₋₁₂ α-olefin (PPC) according to this invention is produced in the presence of the catalyst or catalyst composition as defined above. Preferably the polymerization takes place in at least one polymerization reactor (R1). However the polymerization may also take place in a sequential polymerization system comprising at least two polymerization reactors (R1) and (R2). In case the copolymer (PPC) according to this invention is used for the preparation of a heterophasic system (HECO), the sequential polymerization process may comprise at least one additional polymerization reactor. Further the process may also comprise a pre-polymerization reactor (PR). The term “pre-polymerization” as well as the term “pre-polymerization reactor (PR)” indicates that this is not the main polymerization in which the copolymer (PPC) of the present invention is produced. In turn in the “at least one polymerization reactor (R1)” takes the main polymerization place, i.e. where the copolymer (PPC) or the heterophasic copolymer (HECO) comprising the copolymer (PPC) is produced. That means the expression “polymerization reactor” does not include the pre-polymerization reactor (PR). Thus, in case the process “consists of” one polymerization reactor (R1), this definition does by no means exclude that the overall process comprises the pre-polymerization step in a pre-polymerization reactor. The term “consist of” is only a closing formulation in view of the main polymerization reactors.

Typically the weight ratio of the polypropylene (Pre-PP), e.g. of the propylene copolymer (Pre-PPC), produced in pre-polymerization reactor (PR) and the catalyst is below 500 g Pre-PP/g cat, more preferably in the range of 1 to 300 g pre-PP/g cat, still more preferably in the range of 5 to 200 g Pre-PP/g cat, yet more preferably in the range of 10 to 100 g Pre-PP/g cat.

In the pre-polymerization step the same monomers can be polymerized like in the main polymerization, or just propylene. In one embodiment, just propylene is polymerized in the pre-polymerization reactor.

The pre-polymerization reaction is preferably conducted at an operating temperature of more than 0 to 60° C., preferably from 5 to 50° C., and more preferably from 15 to 40° C., like from 20 to 30° C.

The pressure in the pre-polymerization reactor is not critical but must be sufficiently high to maintain the reaction mixture in liquid phase. Thus, the pressure may be from 5 to 100 bar, for example 10 to 70 bar.

The average residence time (τ) is defined as the ratio of the reaction volume (V_{R}) to the volumetric outflow rate from the reactor (Qₒ) (i.e. V_{R}/Qₒ), i.e. τ=V_{R}/Qₒ [tau=V_{R}/Qₒ]. In case of a loop reactor the reaction volume (V_{R}) equals to the reactor volume.

The average residence time (τ) in the pre-polymerization reactor (PR) is preferably in the range of 1 to 50 min, still more preferably in the range of more than 2 to 45 min

In a preferred embodiment, the pre-polymerization is conducted as bulk slurry polymerization in liquid propylene and optional comonomer, i.e. the liquid phase mainly comprises propylene and optional comonomer, with optionally inert components dissolved therein. Furthermore, according to the present invention, a hydrogen (H₂) feed can be employed during pre-polymerization as mentioned above.

The pre-polymerization is conducted in the presence of the catalyst or catalyst composition as defined above. Accordingly the complex and the optional cocatalyst (Co) are introduced to the pre-polymerization step. However, this shall not exclude the option that at a later stage for instance further cocatalyst is added in the polymerization process, for instance in the first reactor (R1). In a preferred embodiment the complex and the cocatalyst are only added in the pre-polymerization reactor (PR).

It is possible to add other components also to the pre-polymerization stage. Thus, antistatic additive may be used to prevent the particles from adhering to each other or to the walls of the reactor.

The precise control of the pre-polymerization conditions and reaction parameters is within the skill of the art.

Subsequent to the pre-polymerization—if used—the mixture of the complex or complex composition and the polypropylene (Pre-PP), like the propylene copolymer (Pre-PPC), produced in the pre-polymerization reactor (PR) is transferred to the first reactor (R1). Typically the total amount of the polypropylene (Pre-PP), like the propylene copolymer (Pre-PPC), in the final copolymer (PPC) is rather low and typically not more than 5.0 wt.-%, more preferably not more than 4.0 wt.-%, still more preferably in the range of 0.1 to 4.0 wt.-%, like in the range 0.2 of to 3.0 wt.-%.

The polymerization reactor (R1) can be a gas phase reactor (GPR) or slurry reactor (SR). Preferably the polymerization reactor (R1) is a slurry reactor (SR) and can be any continuous or simple stirred batch tank reactor or loop reactor operating in bulk or slurry. Bulk means a polymerization in a reaction medium that comprises of at least 60% (w/w) monomer.

According to the present invention the slurry reactor (SR) is preferably a (bulk) loop reactor (LR).

In case the copolymer (PPC) is produced in more than one polymerization reactor, the first fraction of the copolymer (PPC), i.e. the polymer produced in the polymerization reactor (R1), like in the loop reactor (LR1), is directly fed into the polymerization reactor (R2), e.g. into a loop reactor (LR2) or gas phase reactor (GPR-1), without a flash step between the stages. This kind of direct feed is described in EP 887379 A, EP 887380 A, EP 887381 A and EP 991684 A. By “direct feed” is meant a process wherein the content of the first polymerization reactor (R1), i.e. of the loop reactor (LR), the polymer slurry comprising the first fraction of the copolymer (PPC), is led directly to the next stage gas phase reactor.

Alternatively, the first fraction of the copolymer (PPC), the polymer of the polymerization reactor (R1), may be also directed into a flash step or through a further concentration step before fed into the polymerization reactor (R2), e.g. into the loop reactor (LR2) or the gas phase reactor (GPR-1). Accordingly, this “indirect feed” refers to a process wherein the content of the first polymerization reactor (R1), of the loop reactor (LR), i.e. the polymer slurry, is fed into the second polymerization reactor (R2), e.g. into the loop reactor (LR2) or the first gas phase reactor (GPR-1), via a reaction medium separation unit and the reaction medium as a gas from the separation unit.

A gas phase reactor (GPR) according to this invention is preferably a fluidized bed reactor, a fast fluidized bed reactor or a settled bed reactor or any combination thereof

More specifically, the polymerization reactor (R2), the polymerization reactor (R3) and any subsequent polymerization reactor, if present, are preferably gas phase reactors (GPRs). Such gas phase reactors (GPR) can be any mechanically mixed or fluid bed reactors. Preferably the gas phase reactors (GPRs) comprise a mechanically agitated fluid bed reactor with gas velocities of at least 0.2 m/sec. Thus it is appreciated that the gas phase reactor is a fluidized bed type reactor preferably with a mechanical stirrer.

Thus in a preferred embodiment the first polymerization reactor (R1) is a slurry reactor (SR), like loop reactor (LR), whereas the second polymerization reactor (R2), the third polymerization reactor (R3) and any optional subsequent polymerization reactor are gas phase reactors (GPR). Prior to the slurry reactor (SR) a pre-polymerization reactor can placed according to the present invention.

A preferred multistage process is a “loop-gas phase”-process, such as developed by Borealis A/S, Denmark (known as BORSTAR® technology) described e.g. in patent literature, such as in EP 0 887 379, WO 92/12182 WO 2004/000899, WO 2004/111095, WO 99/24478, WO 99/24479 or in WO 00/68315.

A further suitable slurry-gas phase process is the Spheripol® process of Basell.

The operating temperature in the polymerization reactor (R1), i.e. in the loop reactor (LR), is in the range of 50 to 130° C., more preferably in the range of 60 to 100° C., still more preferably in the range of 65 to 90° C., yet more preferably in the range of 70 to 90° C., like in the range of 70 to 80° C.

On the other hand the operating temperature of the polymerization reactors (R2 and R3), i.e. of the first and second gas phase reactors (GPR1 and GPR2), is in the range of 60 to 100° C., more preferably in the range of 70 to 95° C., still more preferably in the range of 75 to 90° C., yet more preferably in the range of 78 to 85° C.

Typically the pressure in the polymerization reactor (R1), preferably in the loop reactor (LR), is in the range of from 28 to 80 bar, preferably 32 to 60 bar, whereas the pressure in the second polymerization reactor (R2), i.e. in the first gas phase reactor (GPR-1), and in the third polymerization reactor (R3), i.e. in the second gas phase reactor (GPR-2), and in any subsequent polymerization reactor, if present, is in the range of from 5 to 50 bar, preferably 15 to 35 bar.

Preferably hydrogen is added in each polymerization reactor in order to control the molecular weight, i.e. the melt flow rate MFR₂.

The residence time can vary in the reactor zones.

For instance the average residence time (τ) in the bulk reactor, e.g. in the loop reactor, is in the range 0.2 to 4 hours, e.g. 0.3 to 1.5 hours and the average residence time (τ) in gas phase reactor(s) will generally be 0.2 to 6.0 hours, like 0.5 to 4.0 hours.

Accordingly in one embodiment the present invention comprises at least one polymerization reactor (R1), like a slurry reactor (SR), e.g. a loop reactor (LR), and optionally a pre-polymerization reactor (PR). More preferably the polymerization of the copolymer (PPC) takes place in the polymerization reactor (R1) like in a slurry reactor (SR), e.g. in a loop reactor (LR), optionally accompanied upstream with a pre-polymerization reactor (PR). However pre-polymerization can be also undertaken in the polymerization reactor (R1) if needed, which is however less preferred.

Alternatively the polymerization of the copolymer (PPC) takes place in a sequential polymerization process comprising, preferably consisting of, the polymerization reactors (R1) and (R2), in which the polymerization reactor (R1) is preferably a slurry reactor (SR1), e.g. a loop reactor (LR1), whereas the polymerization reactor (R2) is preferably a slurry reactor (SR2), e.g. a loop reactor (LR2) reactor, or a gas phase reactor (GPR1), more preferably the polymerization reactor (R2) is a gas phase reactor (GPR1). Preferably upstream to the polymerization reactor (R1) a pre-polymerization reactor (PR) is arranged in which the pre-polymerization takes place. In such a case C₄₋₁₂ α-olefin together with propylene is fed in both polymerization reactors (R1 and R2) or alternatively C₄₋₁₂ α-olefin and propylene is only fed in polymerization reactor (R1) whereas in the polymerization reactor (R2) only propylene is fed and the excess of C₄₋₁₂ α-olefin from the polymerization reactor (R1) is consumed.

In case a heterophasic copolymer (HECO) (see below) comprising the copolymer (PPC) shall be produced, the polymerization process preferably comprises two to four polymerization reactors (R1) to (R4), wherein preferably the polymerization reactor (R1) is a slurry reactor (SR), e.g. a loop reactor (LR), whereas the remaining reactors (R2) to up to (R4) are gas phase reactors (GPRs). Preferably in the polymerization reactor (R1) and optionally in the polymerization reactor (R2) the copolymer (PPC) is produced whereas in the subsequent polymerization reactor (R3) and the optional polymerization reactor (R4) the elastomeric phase, i.e. the elastomeric propylene copolymer (EC) is produced.

Preferably in all polymerization reactors the same catalyst or catalyst composition as defined above is present.

The Copolymer (PPC)

As mentioned above the instant process is used for the preparation of a copolymer of propylene and a C₄₋₁₂ α-olefin (PPC).

Accordingly the comonomers of the copolymer (PPC) are C₄ to C₁₂ α-olefins, more preferably the comonomers of the copolymer (PPC) are selected from the group of C₄ α-olefin, C₅ α-olefin, C₆ α-olefin, C₇ α-olefin, C₈ α-olefin, C₉ α-olefin, C₁₀ α-olefin, C₁₁ α-olefin, and an C₁₂ α-olefin, still more preferably the comonomers of the copolymer (PPC) are 1-hexene and/or 1-octene. The copolymer (PPC) may contain more than one type of comonomer. Thus the copolymer (PPC) of the present invention may contain one, two or three different comonomers. However it is preferred that the copolymer (PPC) contains only one type of comonomer. Preferably the copolymer (PPC) comprises—apart from propylene—only 1-hexene or 1-octene. In an especially preferred embodiment the comonomer of the copolymer (PPC) is only 1-hexene.

The comonomer content, e.g. the 1-hexene content, of the copolymer (PPC) is preferably at least 0.4 mol-%, more preferably at least 0.6 mol-%, still more preferably in the range of 0.4 to 3.5 mol-%, yet more preferably in the range of 0.6 to 3.2 mol-%.

As mentioned above with the described process especially copolymers (PPC) with high molecular weight can be produced. Thus it is preferred that the copolymer (PPC) has a melt flow rate MFR₂ (230° C.) measured according to ISO 1133 of below 3.0 g/10 min, more preferably below 1.5 g/10 min, yet more preferably in the range of 0.005 to 3.0 g/10 min, still more preferably in the range of 0.008 to 2.0 g/10 min, like in the range of 0.01 to 1.5 g/10 min

Further it is preferred that the copolymer (PPC) has a weight average molecular weight (M_{w}) of at least 500 kg/mol, more preferably of at least 520 kg/mol, yet more preferably in the range of 500 to 900 kg/mol, still more preferably in the range of 550 to 800 kg/mol.

Accordingly it is especially preferred that the copolymer (PPC) fulfills the in-equation (I), more preferably the in-equation (Ia), still more preferably the in-equation (Ib), yet more preferably the in-equation (Ic),

Mw>(−42×Co)+480 (I);

Mw>(−42×Co)+550 (Ia);

Mw>(−42×Co)+600 (Ib);

Mw>(−42×Co)+620 (Ic);

wherein

Mw is the weight average molecular weight (M_{w}) [in kg/mol] of the copolymer (PPC) and

Co is the comonomer content, preferably 1-hexene content, [in mol-%] of the copolymer (PPC).

In one embodiment the molecular weight distribution (MWD) of the copolymer (PPC) is between 1.8 and 20, preferably between 1.9 and 10, more preferably between 1.9 and 5, like between 2.0 and 3.5.

Preferably the melting temperature (Tₘ) of the copolymer (PPC) is in the range of 110 to 155° C., more preferably in the range of 112 to 152° C., still more preferably in the range of 112 to 150° C.

Additionally it is appreciated that the copolymer (PPC) has a crystallization temperature (TO of at least 60° C., more preferably of at least 70° C. Accordingly the copolymer (PPC) has preferably a crystallization temperature (TO in the range of 60 to 105° C., more preferably in the range of 70 to 100° C.

Additionally the copolymer (PPC) is preferably featured by a xylene cold soluble (XCS) content of below 25.0 wt.-%, more preferably of below 22.0 wt.-%, yet more preferably equal or below 20.0 wt.-%, still more preferably below 16.0 wt.-%. Thus it is in particular appreciated that the copolymer (PPC) has a xylene cold soluble (XCS) content in the range of 0.5 to 25.0 wt.-%, more preferably in the range of 0.5 to 20.0 wt.-%, yet more preferably in the range of 0.5 to 16.0 wt.-%.

In one embodiment the copolymer (PPC) is not mixed with an elastomeric polymer, especially not mixed with an elastomeric propylene copolymer (EC) as discussed below. In one specific embodiment the copolymer (PPC) is the only polymer. However this definition of “only polymer” does not excluded the possibility that the copolymer (PPC) may contain minor amounts of polymer, like polypropylene, due to the addition of possible additives, like antioxidants. The amount of such polymers however does not exceed 5 wt.-%, preferably does not exceed 3 wt.-%.

In another embodiment the copolymer (PPC) is part of a heterophasic system. In such a system the copolymer (PPC) constitutes the matrix in which the elastomeric propylene copolymer (EC) is dispersed.

The elastomeric propylene copolymer (EC) comprises monomers copolymerizable with propylene, for example comonomers such as ethylene and/or C₄ to C₁₂ α-olefins, in particular ethylene and/or C₄ to C₈ α-olefins, e.g. 1-butene and/or 1-hexene. Preferably the elastomeric propylene copolymer (EC) comprises, especially consists of, monomers copolymerizable with propylene from the group consisting of ethylene, 1-butene and 1-hexene. More specifically the elastomeric propylene copolymer (EC) comprises—apart from propylene —units derivable from ethylene and/or 1-butene. Thus in an especially preferred embodiment the elastomeric propylene copolymer (EC) comprises units derivable from ethylene and propylene only.

The comonomer content of the elastomeric propylene copolymer (EC) can vary in a broad range, however it is preferred that it is not more than 60.0 mol-%, still more preferably in the range of 12.0 to 60.0 mol-%, yet more preferably in the range of more than 14.0 to 40.0 mol-%, even more preferably in the range of more than 15.0 to 30.0 mol-%.

Typically the weight ratio between the copolymer (PPC) and the elastomeric propylene copolymer (EC) [PPC/EC] is 80/20 to 50/50, more preferably in the range of 70/30 to 60/40.

In the following the present invention is further illustrated by means of examples.

### EXAMPLES

### 1. Measuring Methods

The following definitions of terms and determination methods apply for the above general description of the invention as well as to the below examples unless otherwise defined. The comonomer contents of the copolymer was determined by quantitative Fourier transform infrared spectroscopy (FTIR) calibrated to results obtained from quantitative ¹³C NMR spectroscopy. Thin films were pressed to a thickness of between 300 to 500 μm at 210° C. and spectra recorded in transmission mode. Relevant instrument settings include a spectral window of 5000 to 400 wave-numbers (cm⁻¹), a resolution of 2.0 cm⁻¹ and 8 scans. The hexene content of a propylene-hexene copolymer was determined using the baseline corrected peak maxima of a quantitative band at 727 cm⁻¹, with the baseline defined from 758.5 to 703.0 cm⁻¹.

MFR₂ (230° C.) is measured according to ISO 1133-1 (230° C., 2.16 kg load).

Number Average Molecular Weight (Mₙ), Weight Average Molecular Weight (M_{w}), (M_{w}/Mₙ=MWD)

Molecular weight averages Mw, Mn and MWD were determined by Gel Permeation Chromatography (GPC) according to ISO 16014-4:2003 and ASTM D 6474-99. A PolymerChar GPC instrument, equipped with infrared (IR) detector was used with 3× Olexis and 1× Olexis Guard columns from Polymer Laboratories and 1,2,4-trichlorobenzene (TCB, stabilized with 250 mg/L 2,6-Di tert butyl-4-methyl-phenol) as solvent at 160° C. and at a constant flow rate of 1 mL/min 200 μL of sample solution were injected per analysis. The column set was calibrated using universal calibration (according to ISO 16014-2:2003) with at least 15 narrow MWD polystyrene (PS) standards in the range of 0.5 kg/mol to 11 500 kg/mol. Mark Houwink constants for PS, PE and PP used are as described per ASTM D 6474-99. All samples were prepared by dissolving the polymer sample to achieve concentration of ˜1 mg/ml (at 160° C.) in stabilized TCB (same as mobile phase) for 2.5 hours for PP at max. 160° C. under continuous gently shaking in the autosampler of the GPC instrument.

The Xylene Soluble Fraction at Room Temperature (XS, wt.-%):

The amount of the polymer soluble in xylene is determined at 25° C. according to ISO 16152; first edition; 2005-07-01.

DSC analysis, melting temperature (Tₘ) and heat of fusion (H_{f}), crystallization temperature (T_{c}) and heat of crystallization (H_{c}) measured with a TA Instrument Q200 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C. Crystallization temperature and heat of crystallization (Hₑ) are determined from the cooling step, while melting temperature and heat of fusion (H_{f}) are determined from the second heating step.

### 2. Examples

Catalyst 1 (Cat1) has been prepared following the procedure described in example 10 of WO2010/052263-A1.

Catalysts 2 (Cat2) and catalyst 3 (Cat3) have been prepared following the procedure described in WO 2013/007650 A1 for catalyst E2, by adjusting the metallocene and MAO amounts in order to achieve the Al/Zr ratios indicated in table 1. The catalysts (Cat2) and (Cat3) have been off-line prepolymerized with propylene, following the procedure described in WO 2013/007650 A1 for catalyst E2P. The catalysts have the composition shown in table 1.

TABLE 1
Catalysts

| | | DofP¹ | Al/Zr² | MC³ |
|---|---|---|---|---|
| cat. | Metallocene | [g/g] | [mol/mol] | [wt.-%] |
| Cat1 | MC1* | 3.5 | 438 | 0.686 |
| Cat2 | MC2** | 3.3 | 431 | 0.696 |
| Cat3 | MC2** | 3.5 | 250 | 1.122 |

*rac-methyl(cyclohexyl)silanediyl bis(2-methyl-4-(4-tert-butylphenyl)indenyl)zirconium dichloride
**rac-anti-Me₂Si(2-Me-4-(p-tBuPh)-Ind)(2-Me-4-Ph-5-OMe-6-tBu-Ind)ZrCl₂
¹Degree of off-line pre-polymerisation
²Al/Zr molar ratio in catalyst
³MC content of off-line prepolymerised catalyst

The propylene/1-hexene copolymers were produced in a 478 mL autoclave, provided with a helical bladed impeller.

The bulk polymerisation experiments were performed according to the following procedure: First 1-hexene was fed into the reactor by means of a Waters HPLC pump in the desired amounts, then propylene was added by a Waters HPLC pump (140 g was fed for conducting the experiments with catalyst 1 (Cat 1) and catalyst 2 (Cat2) and 100 g for the experiments with catalyst 3 (Cat3). 0.1 mL (0.05 mmol) of a triethylaluminum solution 0.5M in heptane was injected as scavenger into the reactor. The stirring speed was set at 350 rpm. After 30 minutes, the temperature was set at 20° C.˜30 or 20 mg of the pre-polymerised catalyst were contacted with 6 mL hexane and an aliquot of the resulting slurry, corresponding to the desired catalyst amount, was injected into the reactor with a nitrogen overpressure. After the pre-polymerisation step, the temperature was increased to the desired one (70° C., 75° C. or 80° C.). The ramp time was between 3.9 and 7.1 min. The polymerisations were stopped after 30 minutes by flashing and air addition (experiments with catalyst 3 (Cat 3) were stopped after 60 minutes).

TABLE 2
Preparation of 1-hexene-propylene copolymers

| | | | | | Activity |
|---|---|---|---|---|---|
| | Prepoly* | Polymerization** | C6/C3 feed | yield | [kg/ |
| Catalyst | [min] | [min] | [wt/wt] | [g] | g_{MC}/h] |
| Cat 1 | | | | | |
| CE1 | 5 | 30 | 0.015 | 31.51 | 734 |
| CE2 | 5 | 30 | 0.028 | 20.81 | 485 |
| CE3 | 5 | 30 | 0.046 | 9.46 | 221 |
| Cat 2 | | | | | |
| IE1 | 2 | 30 | 0.026 | 21.17 | 487 |
| IE2 | 2 | 30 | 0.037 | 7.98 | 183 |
| IE3 | 2 | 30 | 0.050 | 5.93 | 136 |
| Cat 3 | | | | | |
| IE4 | 5 | 60 | 0.026 | 4.60 | 82 |
| IE5 | 5 | 60 | 0.040 | 3.22 | 57 |
| IE6 | 5 | 60 | 0.056 | 2.92 | 52 |
| IE7 | 5 | 60 | 0.074 | 2.25 | 40 |

*Prepolymerization at 20° C.
**at 80° C.

TABLE 3
Polymer analysis

| | C6 | | | Mₙ | | | |
|---|---|---|---|---|---|---|---|
| | [mol | Tₘ | T_{c} | [kg/ | M_{w} | M_{w}/Mₙ | MFR |
| Example | % ] | [° C.] | [° C.] | mol] | [kg/mol] | [—] | [g/10 min] |
| CE1 | 0.7 | 144 | 101 | 189 | 444 | 2.3 | 0.5 |
| CE2 | 1.8 | 130 | 88 | 180 | 386 | 2.1 | 0.9 |
| CE3 | 2.9 | 116 | 79 | 155 | 351 | 2.3 | 1.3 |
| IE1 | 0.5 | 142 | 100 | 271 | 630 | 2.3 | 0.1 |
| IE2 | 1.3 | 134 | 93 | 273 | 611 | 2.2 | 0.1 |
| IE3 | 1.8 | 127 | 87 | 247 | 552 | 2.2 | 0.2 |
| IE4 | 0.9 | 137 | 94 | 333 | 733 | 2.2 | 0.06 |
| IE5 | 1.6 | 129 | 85 | 306 | 643 | 2.1 | 0.1 |
| IE6 | 2.8 | 118 | 76 | 246 | 508 | 2.1 | 0.3 |
| IE7 | 2.7 | 119 | 77 | 263 | 543 | 2.1 | 0.2 |

1. Process for the preparation of a copolymer of propylene and a C₄₋₁₂ α-olefin (PPC), said copolymer (PPC) has a melt flow rate MFR₂ (230° C.) measured according to ISO 1133 of below 3.0 g/10 min,
polymerizing propylene and C₄₋₁₂ α-olefin in the presence of a catalyst, said catalyst comprises an asymmetrical complex of formula (I): 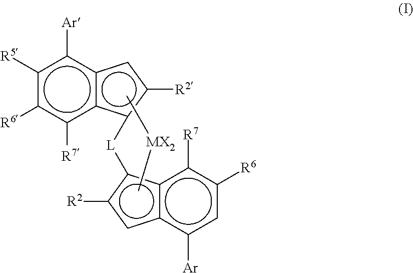
wherein;
M is zirconium or hafnium;
each X is a sigma ligand;
L is a divalent bridge selected from —R′₂C—CR′₂—, —R′₂Si—, —R′₂Si—SiR′₂—, —R′₂Ge—,
wherein each R′ is independently a hydrogen atom, C₁₋₂₀-hydrocarbyl, tri(C₁₋₂₀-alkyl)silyl, C₆₋₂₀-aryl, C₇₋₂₀-arylalkyl or C₇₋₂₀-alkylaryl;
R² and R²′ are each independently a C₁₋₂₀ hydrocarbyl radical optionally containing one or more heteroatoms from groups 14-16;
R^{5′} is a C₁₋₂₀ hydrocarbyl group optionally containing one or more heteroatoms from groups 14-16 and optionally substituted by one or more halo atoms;
R⁶ and R^{6′} are each independently hydrogen or a C₁₋₂₀ hydrocarbyl group optionally containing one or more heteroatoms from groups 14-16;
R⁷ and R^{7′} are each independently hydrogen or C₁₋₂₀ hydrocarbyl group optionally containing one or more heteroatoms from groups 14-16;
Ar is an aryl or heteroaryl group having up to 20 carbon atoms optionally substituted by one or more groups R¹;
Ar′ is an aryl or heteroaryl group having up to 20 carbon atoms optionally substituted by one or more groups R¹;
each R¹ is a C₁₋₂₀ hydrocarbyl group or two R¹ groups on adjacent carbon atoms taken together can form a fused 5 or 6 membered non aromatic ring with the Ar group, said ring being itself optionally substituted with one or more groups R⁴; and
each R⁴ is a C₁₋₂₀ hydrocarbyl group.

2. Process according to claim 1, wherein said catalyst comprises additionally a cocatalyst, said cocatalyst comprises an organometallic compound of a Group 13 metal.

3. Process according to claim 1, wherein said catalyst is a solid catalyst free from external carrier.

4. Process according to claim 1, wherein the complex of formula (I) is a racemic anti isomer.

5. Process according to claim 1, wherein the asymmetrical complex is of formula (V) or (V′): 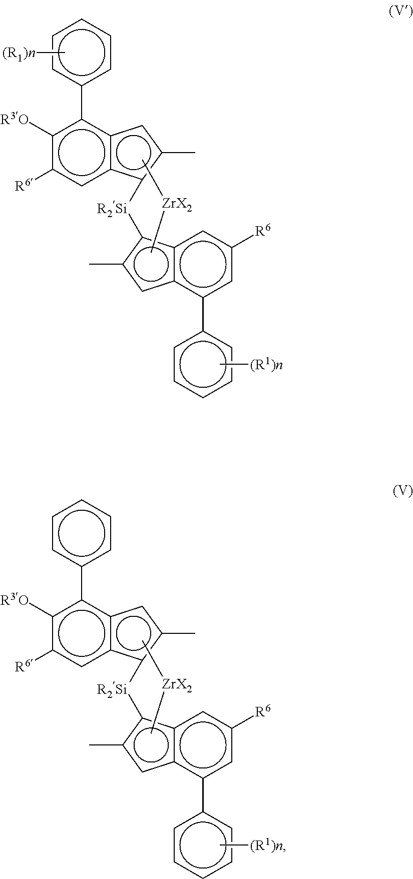
wherein each X is a sigma ligand, preferably each X is independently a hydrogen atom, a halogen atom, C₁₋₆-alkoxy group, C₁₋₆-alkyl, phenyl or benzyl group;
R′ is independently a C₁₋₆ alkyl or C₃₋₁₀ cycloalkyl;
R¹ is C₃₋₈ alkyl;
R⁶ is hydrogen or a C₃₋₈ alkyl group;
R^{6′} is a C₃₋₈ alkyl group or C₆₋₁₀ aryl group;
R^{3′} is a C₁₋₆ alkyl group, or C₆₋₁₀ aryl group optionally substituted by one or more halo groups; and
n is 0, 1 or 2.

6. Process according to claim 1, wherein the catalyst is obtainable by a process in which:
(a) a liquid/liquid emulsion system is formed, said liquid/liquid emulsion system comprising a solution of the complex and optionally of a cocatalyst dispersed in a solvent so as to form dispersed droplets; and
(b) solid particles are formed by solidifying said dispersed droplets.

7. Process according to claim 1, wherein the polymerization takes place in a one polymerization reactor (R1) or in two polymerization reactors (R1) and (R2).

8. Process according to claim 1, wherein the copolymer (PPC) has a comonomer content, in the range of 0.4 to 3.5 mol %.

9. Process according to claim 1, wherein the copolymer (PPC) has a melt flow rate MFR₂ (230° C.) measured according to ISO 1133 of below 1.5 g/10 min.

10. Process according to claim 1, wherein the copolymer (PPC) has a:
(a) a xylene soluble content (XCS) determined at 23° C. according to ISO 6427 of below 20.0 wt. %, and/or
(b) a molecular weight distribution (MWD) measured by gel permeation chromatography (GPC) of 1.8 to 20, and/or
(c) a weight average molecular weight (Mw) determined by Gel Permeation Chromatography (GPC) of at least 500 kg/mol.

11. Process according to claim 1, wherein the copolymer (PPC) has a melting temperature Tm in the range of 112° C. to 152° C.

12. Process according to claim 1, wherein subsequently to the preparation of said copolymer (PPC), said copolymer (PPC) is transferred in a further polymerization reactor (R3), in said further reactor (R3) an elastomeric propylene copolymer (EC) in the presence of said copolymer (PPC) is produced obtaining thereby a heterophasic propylene copolymer (HECO), wherein the elastomeric propylene copolymer (EC) is dispersed in said copolymer (PPC).

13. Process according to claim 12, wherein the preparation of the elastomeric propylene copolymer (EC) takes place in the presence of the same catalyst as used for the preparation of the copolymer (PPC).

14. Process according to claim 12, wherein said reactor (R3) is a gas phase reactor (GPR).
